(19) United States
(12) Patent Application Publication
(10) Pub. No.: US 2025/0292268 A1
(43) Pub. Date: Sep. 18, 2025

(54) AUTOMATED SENSING AND CONTROL SYSTEM WITH DATA ANALYTICS AND ARTIFICIAL INTELLIGENCE

(71) Applicant: PepsiCo, Inc., Purchase, NY (US)

(72) Inventors: Xuejun LI, Pleasantville, NY (US); Cheuk Chi LAU, White Plains, NY (US); Naga VANKADARI, White Plains, NY (US); Ayden SHANKMAN, Purchase, NY (US)

(21) Appl. No.: 18/604,088

(22) Filed: Mar. 13, 2024

(51) Int. Cl. G06Q 30/0202; G06Q 20/20; G06Q 30/0204; G07F 9/00

(52) U.S. Cl. CPC G06Q 30/0202; G06Q 20/204; G06Q 30/0205; G07F 9/006

(57) ABSTRACT

The present disclosure relates to training a machine learning model based on a dataset comprising sales volume, product distribution logistics records, and product manufacturing data. The present disclosure further relate to extracting from the model a prediction of at least one item selected from a group consisting of future sales volume of an existing product, consumer interest for new products, and failure rates for product distribution equipment.

### BACKGROUND

Existing product development, manufacturing, and distribution processes require substantial investment of human capital. Improvement of existing processes can require attempting to derive usable insights from large quantities of information. Analysts have limitations in ability to process such large quantities of information and identify unexpected trends or associations therefrom. As a result, making improvements on large scale processes can be slow and limited to changes in accordance with patterns that are easily recognized.

Hardware testing is another process that can require a significant amount of human labor. Thoroughly testing a user interface of a public facing machine, such as a vending machine, can require repeating actions hundreds or thousands of times in various conditions. A business that deploys public facing machines may therefore need to divert existing personnel from other, more complicated tasks or hire additional personnel for the purpose of testing, thereby incurring substantial costs.

### BRIEF SUMMARY

A need exists for a way to efficiently analyze large amounts of information and discovering associations, trends, and patterns therein that human analysts may not think to look for. Accordingly, an aspect of the present disclosure relates to a system for collecting information from across a product distribution network and training one or more machine learning models with the information. The machine learning model(s) can be trained to provide operational recommendations. The recommendations can relate to distribution logistics, manufacturing volume, product development, equipment field performance, maintenance and repair.

A further need exists for a way to apply repeated user actions to a user interface of a machine with little or no need for human involvement. Accordingly, an aspect of the present disclosure relates to a testing rig that can be attached to a user interface of a machine and programmed with instructions to repeat actions or sequences of actions corresponding to expected user interactions with the machine. The rig may be provided with mechanisms for simulating the expected user interactions. For example, the rig may be provided with one or more mechanisms for submitting payment cards with different technologies (e.g., magnetic strips, EMV chips, and near field communication chips) to the user interface, thereby simulating payment actions.

Some aspects of the present disclosure relate to an intelligent distribution system. The intelligent distribution system may comprise a distributed machine learning network comprising a plurality of end distribution components. Each end distribution component may be configured to predict, based on end distributor data comprising distribution records from a respective end distribution device to retail facilities, future distribution patterns from the end distribution device to the retail facilities.

In some embodiments according to any of the foregoing, the distributed machine learning network may further comprise a plurality of regional distribution components. Each regional distribution component may be configured to predict, based on regional distributor data comprising the distribution records from a respective plurality of the end distribution devices, future regional sales volume within a geographic region within which the plurality of end distribution devices is located, and wherein the future sales volume comprises sales of products distributed by the end distribution devices to the retail facilities.

In some embodiments according to any of the foregoing, the distribution records may comprise operation logs from product handling machinery installed in at least one of the end distribution centers.

In some embodiments according to any of the foregoing, the distributed machine learning network may further comprise a central component. The central component may be configured to predict, based on central data comprising the future regional sales volumes predicted by the regional distribution components, future global sales volumes of the products distributed by the end distribution devices to the retail facilities.

In some embodiments according to any of the foregoing, the central component may further be configured to predict, based on the central data, future manufacturing loads necessary to meet the predicted further global sales volumes.

In some embodiments according to any of the foregoing, the end distributor data may comprise retail data received from the retail facilities.

In some embodiments according to any of the foregoing, the retail data received from at least one of the retail facilities may comprise records generated by an automated stock monitoring system.

Some aspects of the present disclosure relate to a method of testing a machine. The method may comprise connecting a testing rig to the machine. The testing rig may be configured to simulate user interactions with the machine. The method may also comprise loading instructions to a controller of the testing rig. The instructions may comprise a sequence of interactions to be performed by the testing rig. The method may also comprise performing, with the testing rig, a first action in the sequence. The method may also comprise determining, with the testing rig, whether the machine provides expected feedback to the first action. The method may also comprise recording output from the machine.

In some embodiments according to any of the foregoing, the method may comprise using the testing rig to repeat the first action a predetermined number of times

In some embodiments according to any of the foregoing, the method may comprise retrying the first action a predetermined number of times, then performing, with the rig, a second action in the sequence,

In some embodiments according to any of the foregoing, the method may comprise performing, with the rig, each action in the sequence at least once. The method may also comprise, after performing each action in the sequence at least once, restarting the sequence by performing the first action and determining whether the machine provides expected feedback to the first action.

In some embodiments according to any of the foregoing, the method may comprise obtaining the sequence from a machine learning model trained on failure data of other machines.

Some aspects of the present disclosure relate to a machine testing rig. The testing rig may comprise a card holder configured to submit a payment card to a user interface of a machine. The testing rig may also comprise a sensor configured to measure the vending machine's response to submission of the payment card to the user interface.

In some embodiments according to any of the foregoing, the testing rig may comprise a stylus configured to simulate manual inputs to the user interface.

In some embodiments according to any of the foregoing, the testing rig may comprise a motorized arm configured to submit the payment card to the user interface by swiping a magnetic strip of the payment card through a magnetic strip reader of the user interface.

In some embodiments according to any of the foregoing, the testing rig may comprise an actuator configured to push a chip of the payment card into a chip reader of the user interface.

In some embodiments according to any of the foregoing, the testing rig may comprise a frame to which the arm and the sensor are connected. The frame may be configured for mounting to the user interface.

In some embodiments according to any of the foregoing, the testing rig may comprise a near field communication (“NFC”) chip and a motorized chip bracket configured to move the chip into and out of a communication range of an NFC reader of the interface.

In some embodiments according to any of the foregoing, the sensor may be a camera.

In some embodiments, according to any of the foregoing, the sensor could be part of a sensor system or sensor block that also includes one or more QR code readers.

In some embodiments, according to any of the foregoing, the sensor could be part of a sensor system or sensor block that also includes one or more barcode readers.

In some embodiments, according to any of the foregoing, the sensor could be part of a sensor system or sensor block that also includes one or more Near Field Communication (“NFC”) readers.

In some embodiments, according to any of the foregoing, the sensor could be part of a sensor system or sensor block that also includes one or more Narrow Band Internet of Things (“NB-IoT”) readers.

In some embodiments, according to any of the foregoing, the sensor could be part of a sensor system that also includes one or more Bluetooth Low Energy (“BLE”) readers.

In some embodiments according to any of the foregoing, the testing rig may be configured to determine whether the interface provides expected feedback to an action performed by the rig and, if the interface does not provide the expected feedback, record feedback provided by the interface.

Some aspects of the present disclosure relate to a system comprising the testing of any of the foregoing examples and a computing device hosting a machine learning model. The testing rig may be configured to send data collected by the testing rig to the machine learning model. The machine learning model may be configured to configured to develop testing protocols to reproduce failure states identified in test data acquired by the testing rig.

Additional embodiments and advantages of the disclosure will be set forth, in part, in the description that follows, and will flow from the description, or can be learned by practice of the disclosure.

It is to be understood that both the foregoing summary and the following detailed description are exemplary and explanatory only, and do not restrict the scope of the claims.

### BRIEF DESCRIPTION OF THE DRAWINGS

FIG. 1A is a diagram of a system according to an aspect of the present disclosure.

FIG. 1B schematically illustrates an intelligent distribution system according to an aspect of the present disclosure.

FIG. 1C is a diagram of an analytic framework according to an aspect of the present disclosure.

FIG. 2A is a diagram of a testing workflow according to an aspect of the present disclosure.

FIG. 2B is a diagram of a framework for implementing a workflow according to an aspect of the present disclosure.

FIG. 3A is an oblique perspective view of a testing rig according to an aspect of the present disclosure.

FIG. 3B is another oblique perspective view of the testing rig of FIG. 3A.

FIG. 3C illustrates the testing rig of FIG. 3A attached to a user interface.

FIG. 3D illustrates the testing rig of FIG. 3A simulating submission of a first payment method to the interface of FIG. 3C.

FIG. 3E illustrates the testing rig of FIG. 3A simulating submission of a second payment method to the interface of FIG. 3C.

FIG. 3F illustrates a door opener usable with the testing rig of FIG. 3A.

FIG. 3G illustrates the door opener of FIG. 3F attached to a door.

### DETAILED DESCRIPTION

The present invention will now be described in detail with reference to embodiments thereof as illustrated in the accompanying drawings. References to “one embodiment,” “an embodiment,” “an example embodiment,” “some embodiments,” etc., indicate that the embodiment described may include a particular feature, structure, or characteristic, but every embodiment described may not necessarily include that particular feature, structure, or characteristic. Similarly, other embodiments may include additional features, structures, or characteristics. Moreover, such phrases are not necessarily referring to the same embodiment. When a particular feature, structure, or characteristic is described in connection with the embodiment, it is submitted that it is within the knowledge of one skilled in the art to effect such feature, structure, or characteristic in connection with other embodiments whether or not explicitly described.

The terms “invention,” “present invention,” “disclosure,” or “present disclosure” as used herein are non-limiting terms and are not intended to refer to any single embodiment of the particular invention but encompasses all possible embodiments as described in the application.

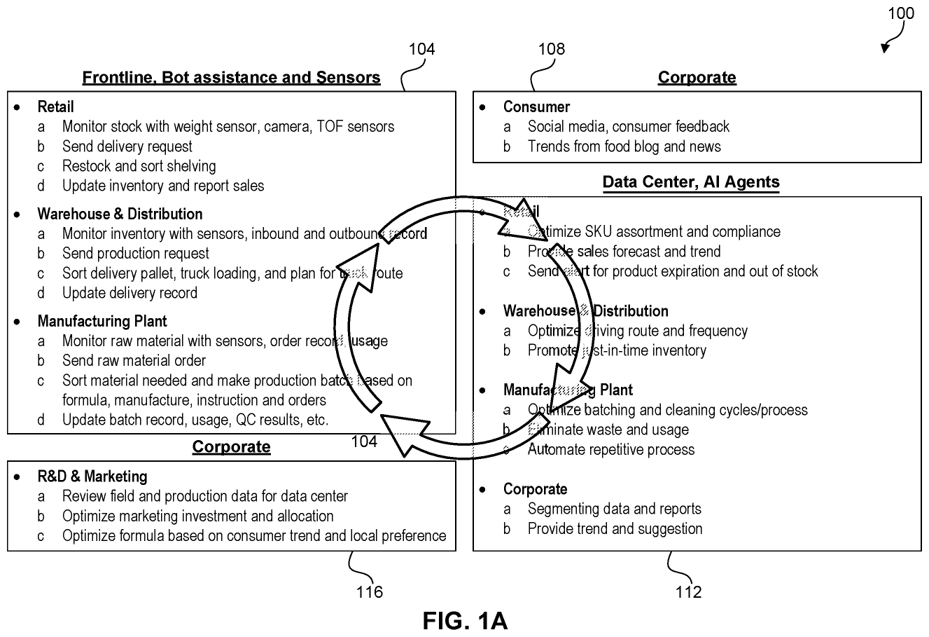

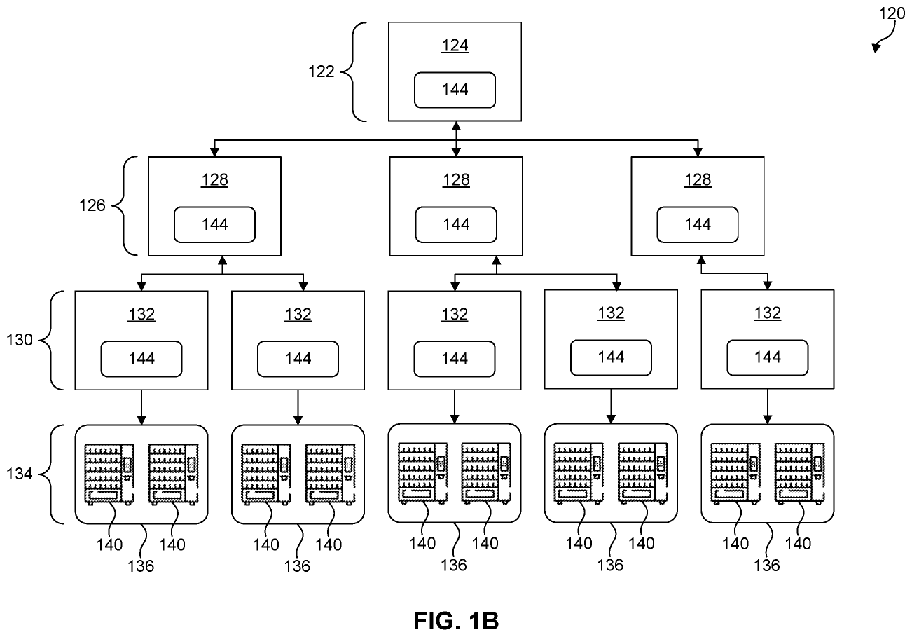

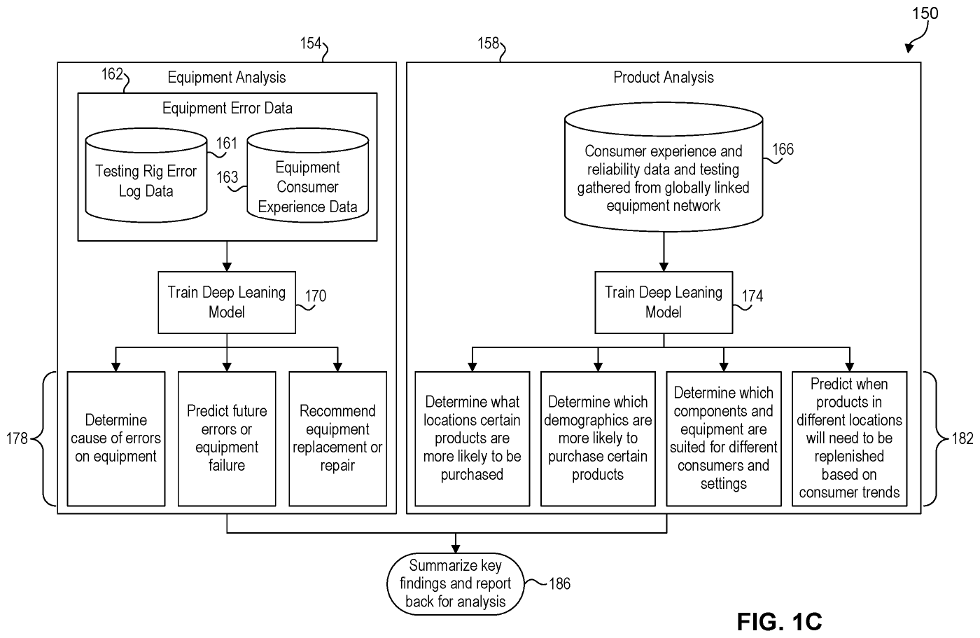

FIG. 1A illustrates a system 100 for applying machine learning to product manufacture and development. Any machine learning models or processes mentioned herein can, in some examples, be deep learning models or processes. System 100 comprises a distribution block 104 and a reception block 108. Distribution block 104 and reception block 108 each represent multiple possible factors that can be quantified and provided as inputs to Artificial Intelligence (“AI”) Agents block 112. AI Agents block 112 represents one or more machine learning models used to identify associations between any inputs, considered individually or in any combination, and any outputs. System 100 further comprises decision block 116, which represents decisions regarding product manufacture and distribution that can be made in view of outputs from AI Agents block 112. The “blocks” of system 100 refer to groups of processes, subsystems, and devices, and do not necessarily require any particular structure.

Distribution block 104 comprises sensor data and records relating to sales, logistics, and manufacturing. Distribution block 104 can comprise, for example, retail data. Retail data can comprise sales volume. For example, retail data can comprise volume of sales to consumers, volume of sales to retailers, or both. In some examples, retail data can be derived from sales records. Retail data can also include consumer data associated with a purchase. An example of said consumer data can be anonymized demographic data, location data, purchase volume data, and the amount spent for a particular product. Such data would only be collected where legal or where a consumer has willingly and knowingly consented to the collection of said data. In further examples, retail data can be derived from sensors within an automated stock monitoring system at a retail location. Retail locations can be, in various examples, a retail store, an automated merchantry system, a controlled access product container, a vending machine, or any other location from which consumers may purchase product. Sensors within the automated stock monitoring system can be, for example, be sensors configured to measure a quantity of product on a shelf or in another storage area. For example, sensors for monitoring a quantity of stock can comprise weight sensors applied to a shelf or other surface upon which stock can be stored. In further examples, sensors for monitoring a quantity of stock can comprise cameras directed at a space within which stock can be stored. In further examples, the cameras can be time of flight (“TOF”) cameras. TOF cameras can be configured to measure a quantity of stock by, for example, measuring a space occupied by the stock. When stock falls below a predetermined threshold quantity, an order can be placed automatically or by a human operator for more product to be delivered to the retail location. Upon arrival of the ordered product, the storage space of the retail location can be restocked and inventory and sales records can be updated. In examples wherein the order is placed automatically, the automatic order can also be automatically entered into the sales data. In further examples, the sales data can be updated automatically to reflect changes in stock at the retail location based on the measurements of the quantity of stock by the automated stock monitoring system.

Distribution block 104 can further comprise warehouse data. Warehouse data can comprise volume of product movement into and out of a warehouse. A warehouse can be, for example, a location where product is stored before distribution to a retail location. In some examples, warehouse data can be derived from shipment and order records. In further examples, warehouse data can be derived from sensors within an automated inventory monitoring system at the warehouse. Similar to the above described automated stock monitoring systems, an automated inventory monitoring system can comprise sensors configured to measure a quantity of inventory of product at the warehouse. Such sensors can comprise, in various examples, weight sensors configured to measure a weight of product stored on a surface or cameras, such as TOF cameras, configured to measure a space occupied by product. Automated inventory monitoring system can further be configured to request production and delivery of product based on inventory data. For example, automated inventory monitoring system can be configured to request production of a product when inventory of the product falls below a predetermined threshold. In further examples, automated inventory monitoring system can be configured to request production of a product at a rate equal to actual or forecasted rates of inventory leaving the warehouse. The rate of inventory leaving the warehouse can be derived from measurements of inventory quantity acquired with the above mentioned sensors of the automated inventory monitoring system. Warehouse data of distribution block 104 can comprise production requests placed by human operators, production requests placed by automated inventory monitoring systems, or both.

Distribution block 104 can further comprise manufacturing data. Manufacturing data can comprise raw material quantities, raw material usage rates, and production volume. Manufacturing data can further comprise order volume of raw material. Orders for raw material can be placed, in various examples, by human operators, by automated systems for monitoring raw material quantity or raw material usage, or both. In further examples, manufacturing data can comprise quality control data, such as, for example, a proportion of product found to have defects. Manufacturing data can further comprise data such as level of energy consumption associated with a manufacturing location or level of energy consumption associated with the manufacturing of a product. As will be discussed later, such data can be analyzed to predict and recommend the most environmentally friendly logistics, manufacturing, distribution, and sales solutions.

Operations at any of the foregoing sources of information within distribution block 104, including retail locations, warehouses, and factories or other manufacturing facilities, can be conducted with the assistance of machinery, such as robots or other devices. Such machinery can be automated or human operated. In each location, the machinery can be used to move product, materials, or both. For example, at retail locations, machinery can be used to restock shelves. In further examples, at relocations, machinery can be used to sort products within a storage space. In some examples wherein the machinery comprises an automated robot, the robot can cooperate with the automated stock monitoring system to restock product as orders of new stock arrive at the retail location. Similarly, product handling machinery can be used at a warehouse to sort inventory and otherwise move product about the warehouse. The product handling machinery can be used, for example, to unload newly arrived product from a delivery vehicle, load product onto a delivery vehicle to fulfill orders, or both. Such warehouse product handling machinery can be automated product handling machinery. Automated product handling machinery in some embodiments can comprise one or more automated robots. Automated systems can also be used to develop routes for delivery vehicles conveying product to or from the warehouse. Similarly, product handling machinery can be used at a manufacturing facility to transport raw material and product within the facility, unload raw material from a delivery vehicle, load product onto a delivery vehicle, manufacture the product, or any combination of the foregoing.

Any of the above described machinery for use at retail locations, warehouses, or manufacturing facilities can be provided with sensors or any type for monitoring operation of the machinery. For example, the sensors can be configured to take measurements from which product sales, material usage, or both can be derived. The measurements can be comprised by data of distribution block 104 corresponding to the location of the machinery. Thus, retail data can comprise measurements from sensors of product transportation machinery at retail locations. Warehouse data can similarly comprise measurements from product transportation machinery at warehouses. Manufacturing data can comprise measurements from product or material transportation machinery, measurements from product manufacturing machinery, or both. Additionally or alternatively, the data comprised by distribution block 104 can comprise logs of operations performed by the machinery, instructions given to the machinery, or both.

Reception block 108 comprises information gathered related to public opinion regarding the product or products to which distribution block relates or other products in a related category. Reception block 108 can comprise information acquired by web analytics techniques, such as aggregating discussion of relevant products and concepts from social media, consumer reviews and feedback, blogs, and news. Such aggregated information can be processed to create one or more market insights. The market insights can comprise, for example, whether prevailing attitudes toward a product or product feature are positive or negative, to what degree prevailing attitudes toward a product or product feature are positive or negative, how much certain product types or product features are discussed, what product types or product features are discussed most frequently, or trends concerning any of the foregoing over time.

AI Agents block 112 comprises use of one or more machine learning models to analyze inputs from distribution block 104 and reception block 108 and output operational recommendations. All inputs to AI Agents block 112 can be aggregated into a dataset used to train the one or more machine learning models. AI Agents block can, in some examples, generate operational recommendations concerning order volume and timing from retail locations to warehouses, from warehouses to manufacturing facilities, and from manufacturing facilities to suppliers of raw materials. In further examples, a machine learning model or models of AI Agents block 112 can be configured to generate operational recommendations concerning what thresholds of stock or inventory at retail locations or warehouses should prompt placement of an order for more product and what the volume of the order should be. Such operational recommendations can be optimized to avoid running out of stock at retail locations or inventory at warehouses. In further examples, such recommendations can be optimized to avoid running out of raw material at a manufacturing plant. Recommendations concerning order placement for product at warehouses and order placement for raw materials and rate of manufacture at manufacturing facilities can be coordinated to minimize a chance of order volume from warehouses exceeding the production capacity of manufacturing facilities. Any such operational recommendations can include prospective changes in order volume according to periodic changes in demand discovered from analysis of information provided to the machine learning model(s) of AI Agents block 112. For example, the machine learning model(s) of AI Agents block 112 may recommend greater order volume, higher stock or inventory thresholds below which orders should be placed, or both, in advance of expected weekly or seasonal increases in demand. In further examples, such operational recommendations can be optimized to reduce a likelihood of product remaining unsold until expiring of raw material remaining unused until expiring by reducing order placement volume or frequency in advance of expected weekly or seasonal decreases in demand. In further examples, relative positivity or negativity of any of a variety of factors, such as, for example, total revenue, total sales, total expenses, wasted product, wasted raw materials, demand exceeding production capacity, defective product occurrence frequency, and running out of stock, inventory, and raw materials, can be weighted and provided to the machine learning model(s) of AI Agents block 112, and the machine learning model(s) can be configured to provide operational recommendations expected to result in maximally positive outcomes. Operational recommendations according to any of the foregoing examples can be provided to human operators or pushed to any automated order placement systems associated with retail locations, warehouses, or manufacturing facilities.

The machine learning model(s) of AI Agents block 112 can also be configured to generate operational recommendations meant to provide the most environmentally friendly approach. For example, recycling can be promoted by taking GPS sensor data to determine the location a consumer good will be shipped to. This can be cross-referenced with local regulations identifying which type of packaging can be recycled in that area so that the machine learning models optimize recycling by recommending the use of packaging materials that can recycled in the location it is being shipped to. Similarly, the machine learning model(s) can be used to determine the most fuel-efficient supply chain and logistical solutions by, e.g., recommending: (1) routes that take up the least amount of fuel or recommending supply carriers that utilize hybrid or electric vehicle fleets; and/or (2) delivery schedules that take up the least amount of energy or fuel. Similarly, the machine learning model(s) can recommend manufacturing locations and/or delivery hubs that use the least energy or consume the least water, thereby further reducing the environmental impact associated with delivering products to consumers. Similarly, the machine learning model(s) can create commercial incentives to promote the most environmentally friendly approaches from manufacturing sites, shipping sites, retail sites, warehouses, retailers and consumers. For example, retailers that reach certain recycling goals can be rewarded with discounts, free products, cheaper delivery, earlier access to new products, or being prioritized for popular products or new releases. The machine learning model(s) can also be used to develop or incentivize efficient energy management protocols, such as adjusting a thermostat to a higher setting during closing hours or adjusting the thermostat to a lower setting before regular business hours, such as when sales or production occur. Systems may also be automated to adhere to such energy management protocols. Thus, in some embodiments, facilities can be equipped with controllers governing thermostats to automatically adjust to lower temperatures at closing time and higher temperatures at or before opening time.

The machine learning model(s) of AI Agents block 112 can also be configured to generate operational recommendations for consideration by business professionals, such as individuals involved in corporate governance. Such operational recommendations can concern, for example, long term forecasts for demand for certain product types, trends in consumer sentiment regarding product types or product features, and recommendations for product development. For example, if the machine learning model(s) of AI Agents block 112 determine, from inputs received from reception block 108, that consumer demand for a product type or product feature not offered by the organization operating the machine learning model(s), the machine learning model(s) can recommend developing a product of that type and/or having that feature. Additionally or alternatively, the operational recommendations for consideration by business professionals can comprise recommendations relating to messages to emphasize or avoid in product marketing.

Decision block 116 comprises consideration of the operational recommendations output by the machine learning model(s) of AI Agents block 112 by any human recipients of the operational recommendations. The human recipients comprise, in various examples, engineers, research and development teams, marketing professionals, business professionals, factory operators, vehicle operators, or any other recipients appropriate for the subject matter of the recommendations given. At decision block 116, the human recipients determine which operational recommendations from the machine learning model(s) of AI Agents block 112 to implement and to what extent those recommendations will be implemented. For example, certain product development recommendations may be implemented, whereby new products may be developed and then produced at manufacturing facilities, while other product development recommendations may be ignored or deferred. As another example, steps to reduce power/water consumption and optimize resources in manufacturing, warehousing, retail, and other facilities can be prioritized and implemented based on operational recommendations output by the machine learning model(s). Similarly, logistics related operational recommendations may be implemented throughout the various elements of decision block 104, such as by altering order volumes, order frequencies, delivery routes, workflows in manufacturing facilities, and traffic patterns within storage areas of retail locations, warehouses, and manufacturing facilities. In further examples, certain marketing recommendations may be implemented, such as by adjusting marketing investment across various media, various locations, or both. In still further examples, marketing recommendations can be implemented by developing new marketing campaigns, retiring certain existing marketing campaigns, or both. In some embodiments, a machine learning model or models may be trained to determine which operational recommendations to implement, as discussed above.

Aspects of the above described system 100 can be implemented in an intelligent distribution system 120 as shown in FIG. 1B. Intelligent distribution system 120 can comprise one or more device layers such as a central layer 122, a regional distribution layer 126, an end distribution layer 130, and a retail layer 134. Retail layer 134 can comprise individual retail devices 136. In some embodiments, individual retail devices 136 can be systems or facilities operating a plurality of retail machines 140, such as for example, vending machines, automated merchants, and sales registers. It is understood that intelligent distribution system 120 may be implemented with any number of layers and is not limited to the layers depicted in FIG. 1B.

End distribution layer 130 can comprise end distributor devices 132, such as warehouses as described above. End distribution layer 130 includes components and, in some embodiments, facilities, which are configured to distribute product to one or more retailers, which may be represented by retail devices 136. Thus, in some embodiments, each end distributor device 132 can include components, facilities, or both, configured for use in the distribution of product to one or more retailers or retail devices 136. Regional distribution layer 126 can comprise multiple regional distributor devices 128. Regional distribution layer 126 includes components and, in some embodiments, facilities, which are configured to distribute product to one or more end distributor devices 132 within a respective geographic region. Thus, in some embodiments, each regional distributor device 128 can include components, facilities, or both, configured for use in the distribution of product to one or more end distributors or end distributor devices 132. Central layer 122 can comprise a central decision maker device 124, such as a central computer or a cloud computer, configured to aggregate sales and distribution data from regional distributor devices 128.

Intelligent distribution system 120 can comprise a machine learning network distributed across multiple layers of intelligent distribution system 120. For example, the machine learning network can comprise components 144. In some embodiments, each component 144 of the machine learning network can comprise a separate, independently operating machine learning model. In further embodiments, components 144 within regional distribution layer 126 can each be a portion of a collective machine learning machine operating across regional distribution layer 126. In further embodiments, components 144 within end distribution layer 130 can each be or comprise a portion of a collective machine learning model operating across end distribution layer 130. In further embodiments, all components 144 of machine learning model can be or comprise portions of a single machine learning model operating across central layer 122, regional distribution layer 126, and end distribution layer 130 of intelligent distribution system 100. The machine learning model or models according to any of these embodiments can be any type of machine learning model. In some embodiments, each machine learning model can be a neural network.

With respect to the system 100 described above, distribution block 104 can comprise components 144 of the machine learning network within regional distribution layer 126, end distribution layer 130, and retail layer 134. Either or both of AI Agents block 112 and decision block 116 can comprise part or all of the component 144 within central layer 122.

In some embodiments, each regional distributor device 128 can host one or more components 144 of the machine learning network. In some embodiments, each end distributor device 132 can host one or more components 144 of the machine learning network. In some embodiments, the machine learning network can comprise further components 144 within retail layer 134. For example, components 144 within retail layer 134 can be hosted by computer hardware installed within individual retail devices 136. In some embodiments, components 144 can be hosted by computer hardware within individual retail machines 140. Thus, in some embodiments, each retail device 136 can host one or more components 144 of the machine learning network.

Components 144 of the distributed machine learning network can be configured to make predictions based on data received from across various portions of the intelligent distribution system 120. Components 144 within different layers 122, 126, 130, 134 can have different roles in the distributed machine learning network. Thus, in some embodiments, each component 144 within end distribution layer 130 can be configured to predict, based on end distributor data comprising distribution records from a respective end distributor device 132 to one or more retail devices 136, future distribution patterns from the end distributor device 132 to the retail devices 136. In some embodiments, each component 144 within end distribution layer 130 can also be configured to optimize distribution practices from the end distributor data for environmental friendliness. The distribution practices can include, for example, distribution routes, distribution schedules, thermostat temperature settings, thermostat schedules, or any combination of the foregoing, and components 144 can be configured to optimize the practices for environmental friendliness by finding solutions that satisfy all necessary criteria (such as timely delivery and avoidance of spoilage) while minimizing energy expenditure or material usage. In some embodiments, the end distributor data can include distribution records from a respective end distribution device 132 to retail devices 136, such as retail facilities. In some embodiments, the end distributor data can include retail data received from the retail devices 136. In some embodiments, the retail data can include records generated by an automated stock monitoring system installed in at least one of the retail devices 136. In some embodiments, retail data can include any one or any combination of sales performance, power usage, machine health, consumer analytic data such as consumer demographics, foot traffic within a retail location or within a predetermined proximity of a retail machine 140, conversion rate of new customers, time of sale, location of sale, volume of sale, sale price, and vendor identity or retailer identity. In some embodiments, any or all of the retail data can be acquired through retail machines 140. In some embodiments, the end distributor data can further comprise retail data received from the retail devices 136, such as product sales volumes from the retail devices 136. In some embodiments, the retail data can comprise records of product inventory generated by automated inventory monitoring systems installed at one or more of the retail devices 136. In some embodiments, the retail data can include maintenance data from retail devices 136. In some embodiments, the maintenance data from retail devices 136 can include maintenance data from retail machines 140. Maintenance data can include records of when retail machines 140 fail, what aspects of retail machines 140 fail, when repairs are made to retail machines 140, and what repairs are made to retail machines 140.

In some embodiments, each component 144 within regional distribution layer 126 can be configured to predict, based on regional distributor data comprising the distribution records from a respective plurality of the end distributor devices 132, future regional sales volume within a geographic region within which the plurality of end distributor devices 132 is located. The regional sales volume can be a volume of sales of products distributed by end distributor devices 132 to retail devices 136. In some embodiments, the distribution records can comprise operation logs from product handling machinery installed in at least one of the end distributor devices 132. In some embodiments, the regional distributor data upon which the component or components 144 of the regional distribution layer 126 can comprise any one or any combination of records of distribution within the geographic region, records of manufacture of products to be distributed within the geographic region, usage rate of materials for manufacture of products to be distributed within the geographic region, inventory of materials to be used in manufacture of products to be distributed within the geographic region, stock of products available to be distributed within the geographic region, records of service calls, records of restock orders, and records of orders to move products. In some embodiments, each component 144 within regional distribution layer 126 can also be configured to optimize distribution practices from the regional distributor data for environmental friendliness. The distribution practices can include, for example, distribution routes, distribution schedules, thermostat temperature settings, thermostat schedules, manufacturing processes, or any combination of the foregoing, and components 144 can be configured to optimize the practices for environmental friendliness by finding solutions that satisfy all necessary criteria (such as fuel efficiency, timely delivery, and avoidance of spoilage) while minimizing energy expenditure or material usage.

In some embodiments, decision maker device 124 can host one or more components 144 of the machine learning network. In some embodiments, the component 144 within central layer 122 can be a central component configured to predict, based on central data comprising the future regional sales volumes predicted by the components 144 within regional distribution layer 126, future global sales volumes of the products distributed by end distributor devices 132 to retail devices 136. In some embodiments, the component 144 within central layer 122 can be a central component further configured to predict, based on the central data, future manufacturing loads necessary to meet the predicted further global sales volumes. This prediction can also be used to optimize an approach to minimize environmental impact while keeping costs down. Thus, in some embodiments, each component 144 within central layer 122 can also be configured to optimize distribution practices from the central data for environmental friendliness. The distribution practices can include, for example, distribution routes, distribution schedules, thermostat temperature settings, thermostat schedules, manufacturing processes, or any combination of the foregoing, and components 144 can be configured to optimize the practices for environmental friendliness by finding solutions that satisfy all necessary criteria (such as fuel efficiency, timely delivery, and avoidance of spoilage) while minimizing energy expenditure or material usage. The component 144 within central layer 122 can also, in some embodiments, create a holistic and traceable record to keep track of green house gas emission to make sure emissions are on track with sustainability goals. In some embodiments, the central component can be partly or entirely comprised by AI Agents block 112 as described above, decision block 116 as described above, or both AI Agents block 112 and decision block 116. Thus, the central data can include any of the information described above as being available to or used by the AI Agents block 112, the decision block 116, or both.

FIG. 1C illustrates an analytic structure 150. In some examples, analytic structure 150 can be a process within AI Agents block 112 of the above described system 100. In further examples, analytic structure 150 can be implemented independently from the above described system 100.

Analytic structure 150 can comprise equipment analysis 154 and product analysis 158. Equipment analysis 154 can be implemented with workflow 200 and rig 300 described below to analyze a type of equipment, such as machine 340, also described below. Equipment analysis 154 begins from receiving input data 162. Input data 162 for equipment analysis 154 can comprise, for example, testing rig data 161 and consumer experience data 163. Testing rig data 161 can comprise any data relating to equipment failure occurring during usage of an equipment testing rig, such as rig 300 described below, on a sample or samples of the type of equipment being analyzed. Consumer experience data 163 can comprise any data relating to usage by consumers of the type equipment being analyzed. Consumer experience data 163 can comprise, for example, consumer sentiment and feedback acquired in reception block 108, survey data, data related to measurements of how consumers interact with machines of the type being tested, or any combination of the foregoing.

Equipment analysis 154 comprises a training step 170 wherein input data 162 of equipment analysis 154 is used to train a machine learning model, which can, in some examples, be a deep learning model. The machine learning model is trained to produce outputs 178 from input data 162. Outputs 178 of equipment analysis 154 can comprise or be comprised by the operational recommendations described above with regard to AI Agents block 112 of system 100. Outputs 178 of equipment analysis 154 can comprise, for example, identified causes of failures of the type of equipment being analyzed, predictions of future error and failure patterns for the type of equipment being analyzed, recommended maintenance, such as replacement or repair, of existing instances of the type of equipment being analyzed, or any combination of the foregoing.

Product analysis 158 comprises using product data 166 to train a machine learning model in a training step 174 of product analysis 158. The machine learning model can be, in some examples, a deep learning model. Product data 166 can comprise sales data of a product, usage data of equipment consumers may use to purchase the product, consumer sentiment and feedback acquired in reception block 108, survey data, and reliability data of equipment consumers may use to purchase the product.

In training step 174 of product analysis 158, the machine learning model is trained to produce outputs 182 from product data 166. Outputs 182 of product analysis 158 can comprise or be comprised by the operational recommendations described above with regard to AI Agents block 112 of system 100. Outputs 182 of product analysis 158 can comprise, for example, predictions of locations where certain products are likely to be purchased, identifications of demographics associated with groups of consumers that purchase certain products, predictions which types of equipment are suitable for which consumers and settings, predictions of which locations are likely to run out of stock and require restocking, or any combination of the foregoing.

Analytic structure 150 terminates at report step 186. At report step 186, all or some portion of outputs 178, 182 of equipment analysis 154 and product analysis 158 can be reported to decision makers. Decision makers for this purpose can, in some examples, be any of the human recipients described above with regard to decision block 116 of system 100. Report step 186 can include identification of key findings within outputs 178, 182 or otherwise summarizing or abbreviating outputs 178, 182 before reporting outputs 178, 182 to the decision makers.

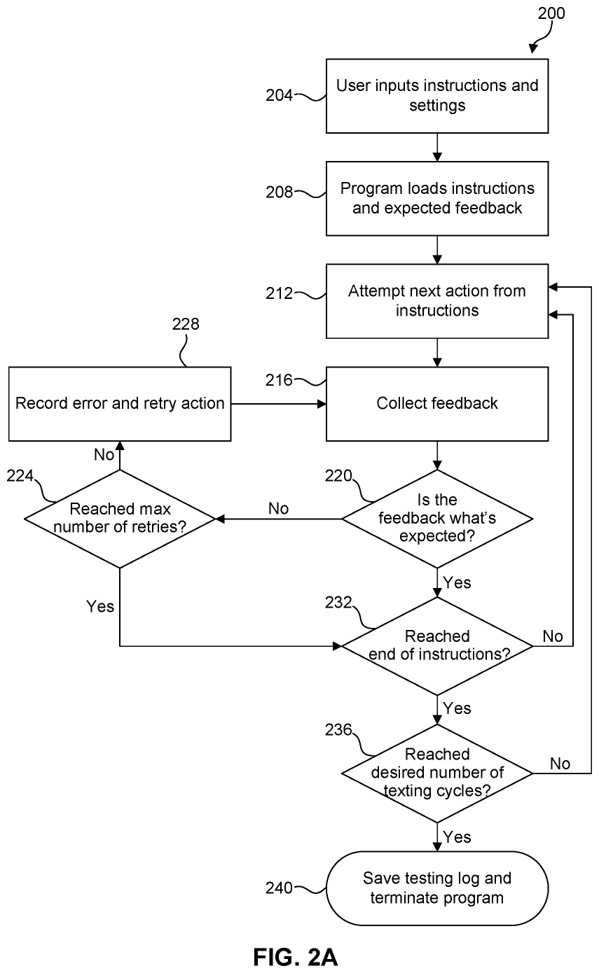

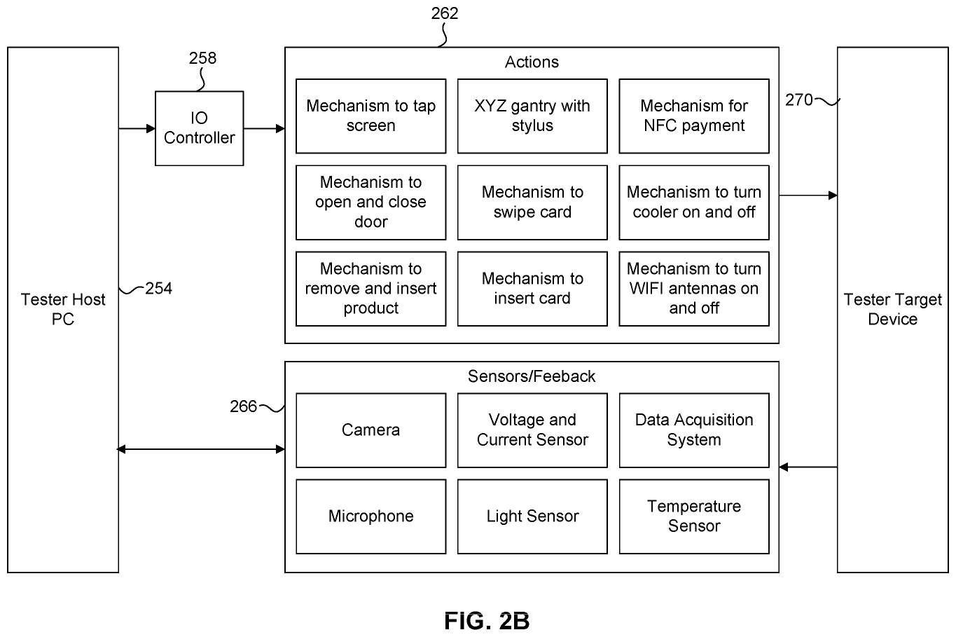

FIG. 2A illustrates a workflow 200 for automated testing of a machine. The tested machine can be, for example, a vending machine, an automated merchantry system, or a controlled access product container. The tested machine can be the tester target device 270 of framework 250 or the machine 340 used with rig 300, both of which will be discussed further below. Workflow 200 comprises a setup step 204. Setup step 204 comprises providing a testing rig, such as rig 300 discussed below, with parameters of the test to be conducted within workflow 200. Setup step 204 can therefore comprise providing the rig with actions such as user inputs to be simulated in order to conduct the test. Setup step 204 can further comprise entering settings to the rig that relate to variable aspects of how the user inputs are tested within workflow 200.

Workflow 200 further comprises a loading step 208. Loading step 208 comprises loading rig 300 with the feedback expected from the machine in response to the user inputs provided in setup step 204. Loading step 208 can further comprise loading rig 300 with any instructions concerning execution of the test that remain to be provided after setup step 204. Loading step 208 can comprise, for example, loading rig 300 with instructions concerning what actions to take when the machine deviates from the expected feedback. For example, loading step 208 can comprise loading rig 300 with instructions to record a deviation from the expected feedback along with data relating to the circumstances of the deviation. Circumstances for this purpose can include, for example, any combination of a state of the machine being tested, inputs to the machine being tested within a predetermined amount of time preceding the deviation, inputs to the machine being tested within a predetermined number of inputs preceding the deviation, a computer log of the machine being tested, power usage of any part of the machine being tested, and readings from sensors measuring any aspect of the machine being tested. Loading step 208 can further comprise instructions concerning which kinds of deviations to record.

Workflow 200 further comprises an attempt step 212. Attempt step 212 can follow setup step 204 and loading step 208. Attempt step 212 comprises the rig performing a next action within the user inputs provided in setup step 204. If attempt step 212 is the first attempt step 212 performed within an instance of workflow 200, attempt step 212 can comprise performing a first one of the user inputs provided in setup step 204. Attempt step 212 can be, for example, any of the actions performable by rig 300 discussed below. Thus, examples of actions performable in attempt step 212 include touching a touch screen on an interface, pressing a button on an interface, submitting payment, opening a door, and any combination or sequence of the foregoing. In further examples, attempt step 212 can be rig 300 simulating a user input to interface 301 of the machine being tested.

Workflow 200 further comprises a collecting step 216. Collecting step 216 can follow attempt step 212. Collecting step 216 comprises collecting feedback from the machine being tested. For example, where the rig used for the test is rig 300, collecting step 216 can comprise collecting feedback from the machine by observing and, optionally, recording output from interface 301 of the machine as discussed further below. In further examples, collecting step 216 can comprise making any observation of the machine being tested that relates to whether the machine responds as expected to the action performed in attempt step 212 or retry step 228.

Workflow 200 further comprises a feedback decision 220. Feedback decision 220 can follow collecting step 216. Feedback decision can be determined automatically by a processor of the rig performing workflow or by a human operator observing the rig. Feedback decision 220 comprises determining whether the feedback observed in collecting step 216 matches expected feedback for the action performed in the most recent attempt step 212. Thus, feedback decision 220 can comprise determining that an error occurred when the answer to a question of whether expected feedback was observed during collecting step 216 is “no.” Feedback decision 220 can comprise, for example, determining whether an output observed from the machine being tested during collecting step 216 matches an expected output from the machine in response to the action performed in attempt step 212. In further examples, feedback decision 220 can comprise determining whether an output from interface 301 of the machine being tested matches an expected output from interface 301 in response to the action performed in the most recent attempt step 212. Upon determining, within feedback decision 220, an answer to the question of whether the feedback observed in collecting step 216 matches expected feedback for the action performed in the most recent attempt step 212, workflow 200 can proceed to retry count decision 224 if the answer is “no” or instructions decision 232 if the answer is yes.

Workflow 200 further comprises a count decision 224. Retry count decision 224 can follow a determination at feedback decision 220 that expected feedback was not observed during collecting step 216. In other examples, retry count decision 224 can follow feedback decision 220 regardless of an outcome of feedback decision 220 such that workflow 200 comprises testing certain actions for multiple repetitions even when the machine being tested responds as expected. Retry count decision 224 comprises determining whether a maximum number of retries performed in retry step 228 has been reached for the current action in the sequence of actions or user inputs being tested. In some examples, the maximum number of retries for the action can be among the parameters provided to the rig during setup step 204 or loading step 208. The maximum number of retries for the action can be any predetermined natural number, including zero. In some examples, the maximum number of retries for the action can be any positive integer. In further examples, the maximum number of retries for the action can be 1, 2, 3, 5, 10, 12, 18, 32, 50, 68, 100, 128, 1000, or any number in a range extending from 1 through 1000. Upon determining, within retry count decision 224, an answer to a question of whether the maximum number of retries have already been done, workflow 200 can proceed to retry step 228 if the answer is “no” or to instructions decision 232 is the answer is “yes.”

Workflow 200 further comprises a retry step 228. Retry step 228 can follow a determination at retry count decision 224 that a maximum number of retries have not been performed. Retry step 228 comprises performing the same action performed during the most recent attempt step 212. Following retry step 228, workflow 200 returns to collecting step 216.

Retry count decision 224 and retry step 228 are optional, meaning in some examples feedback decision 220 is used only to determine whether an error occurred and optionally whether to record the error, and workflow 200 proceeds directly from feedback decision 220 to instructions decision 232 regardless of whether an error occurred.

Workflow 200 further comprises an instructions decision 232. Instructions decision can follow a determination at feedback decision 220 that the feedback observed in collecting step 216 matches expected feedback from the machine being tested following the action performed during the most recent attempt step 212 or retry step 228. Instructions decision 232 can also follow a determination at retry count decision 224 that a maximum number of retries have been done. Instructions decision 232 comprises determining whether the most recent attempt step 212 or retry step 228 concluded instructions from setup step 204 for a sequence of actions to be performed on the machine being tested. In some examples, the sequence of actions can be obtained from the machine learning models described above with regard to AI Agents block 112, analytic structure 150, or both. Upon determining, within instructions decision 232, that an answer to the question of whether the most recent attempt step 212 or retry step 228 concluded instructions from setup step 204 for a sequence of actions to be performed on the machine being tested, workflow 200 can return to attempt step 212 and perform the next action in the sequence of actions if the answer is “no” or proceed to cycle count decision 236 if the answer is “yes.”

Workflow 200 further comprises cycle count decision 236. Cycle count decision 236 can follow a determination at instructions decision 232 that the most recent attempt step 212 or retry step 228 concluded a set of instructions from setup step 204 for a sequence of actions to be performed on the machine being tested. Cycle count decision 236 comprises determining whether the sequence of actions has been performed for a predetermined desired number of testing cycles for the sequence of actions. In some examples, the predetermined number of testing cycles for each sequence of actions can be set during setup step 204 or loading step 208. The desired number of testing cycles for the sequence can be any positive integer. In further examples, the desired number of testing cycles for the sequence can be 1, 2, 3, 5, 10, 12, 18, 32, 50, 68, 100, 128, 1000, or any number in a range extending from 1 through 1000. Upon determining, within cycle count decision 236, an answer to a question of whether the desired number of testing cycles for the sequence have already been completed, workflow 200 can return to attempt step 212 and perform the first action in the sequence if the answer is “no” or to end step 240 is the answer is “yes.”

End step 240 represents and end of workflow 200. End step 240 can follow a determination at cycle count step 236 that a desired number of testing cycles have been completed. In other examples, cycle count step 236 can be omitted and end step 240 can follow a determination at instructions decision 232 that the most recent attempt step 212 or retry step 228 concluded a set of instructions from setup step 204 for a sequence of actions to be performed on the machine being tested. End step 240 can comprise terminating a testing program running on the rig. In further examples, testing step 240 can comprise restarting workflow 200 with a new sequence of actions to be tested on the machine. End step 240 can also comprise saving a testing log. In further examples, all or any portion of the testing log can be saved at any stage of workflow.

The order of steps described above and shown in FIG. 2A represent one example of how a workflow 200 according to the present disclosure can be implemented. In other examples, steps within workflow 200 can be reordered or combined in any manner that would achieve similar results. For example, setup step 204 and loading step 208 can be combined, executed at overlapping times, or executed in an order wherein setup step 204 follows loading step 208. Further, either or both of setup step 204 and loading step 208 can be omitted for rigs only configured to conduct a single test or a limited variety of tests.

Workflow 200 can be implemented within a framework 250. Within framework 250, tester target device 270 is the machine being tested. Framework 250 comprises a host 254. Host 254 can be, for example a personal computer (“PC”) usable by a human tester. Host 254 is a computer allowing user control of the devices executing workflow 200 and comprising a processor responsible at least some of the processing involved in executing workflow 200. In some examples, host 254 is integrated into the rig for workflow 200, such as rig 300 described below. In other examples, host 254 is separate from rig 300, but in network communication with the rig.

Framework 250 further comprises a controller 258. Controller 258 is configured to receive instructions from host 254 and to control the rig for implementing workflow 200, such as rig 300, in accordance with the instructions from host 254. Controller 258 can be, for example, an input/output (“IO”) controller, or any other type of controller capable of controlling the rig in accordance with the instructions from host 254. In some examples, controller 258 can be integrated into the rig. In other examples, controller 258 can be integrated into host 254. In further examples, controller 258 can be separate from host 254 and the rig, but in network communication with both.

Framework 250 further comprises action block 262 and sensor block 266. “Action block” and “sensor block” as used herein refer to groups of devices and components, and do not necessarily require any particular structure, block-like or otherwise. Action block 262 comprises any mechanisms that act on tester target device 270 as part of attempt step 212 or retry step 228. Thus, action block 262 can comprise, for example, any one or any combination of a mechanism to tap a screen of a touch screen of tester target device 270, a stylus mounted to a motorized gantry for simulating user taps or button presses on tester target device 270, a near field communication (“NFC”) device for submitting payment or otherwise communicating with tester target device 270, a mechanism to open and close a door of tester target device, a mechanism to simulate a user card swipe, a mechanism to turn a cooler of tester target device 270 on and off, a mechanism to remove products from tester target device 270, a mechanism to insert products into tester target device 270, a mechanism to insert a card into tester target device 270, and a mechanism to turn on and off any network communication antennas of tester target device 270.

Sensor block 266 comprises any sensors used to observe tester target device 270 during collecting step 216 of workflow 200. Thus, sensor block 266 can comprise, for example, any one or any combination of a camera configured to observe visible outputs from tester target device 270, a voltage sensor configured to measure voltage used by any portion of tester target device 270, a current sensor configured to measure current drawn by any portion of tester target device 270, a data acquisition system (“DAQ”) configured to transduce analog information from any sensors within sensor block 266, a microphone configured to capture sound outputs from tester target device 270, a light sensor configured to measure ambient light independently of the camera, and a temperature sensor. In some embodiments, sensor block 266 can also include any one or any combination of one or more QR code readers, one or more barcode readers, one or more NFC readers, one or more Narrow Band Internet of Things (“NB-IoT”) readers, and one or more Bluetooth Low Energy (“BLE”) readers.

Information acquired by sensor block 266 can be sent to host 254 for analysis. Thus, information gathered by performing workflow 200 can be sent to host 254 for analysis. Host 254 may therefore be used, in some embodiments, to assess the relative likelihood of inputs, sequences of inputs, and conditions to result in failure of the machine tested in workflow 200. In some embodiments, host 254 can host a machine learning model for analyzing the results of workflow 200. In some embodiments, the machine learning model hosted by host 254 can be trained on the results of workflow 200, such as information acquired by sensor block 266, to identify any one or any combination of inputs, sequences of inputs, and conditions likely to result in failure of the machine tested by performing workflow. In some embodiments, the machine learning model hosted by host 254 can be trained on the results of workflow 200, such as information acquired by sensor block 266, to formulate new testing protocols for the machine tested in workflow 200. New testing protocols can include sequences of actions to be input to the machine being tested in workflow. In further embodiments, the machine learning model hosted by host 254 can be trained on the results of workflow 200 to optimize existing testing protocols. In any of the foregoing embodiments, the machine learning model hosted by host 254 can be trained to generate new protocols or optimized existing protocols with the goal being to do any one or any combination of reproduce previously observed failures, find the root cause of previously observed errors, and determine whether previously observed failures have been remedied. In any of these examples, tester target device 270 can be the machine tested by workflow 200.

When implementing workflow 200 within framework 250, host 254 sends instructions to controller 258. Controller 258 controls the mechanisms within action block 262 to act on tester target device 270 as necessary for attempt step 212 and retry step 228. Then, tester target device 270 is observed by sensor block 266 in collecting step 216. Measurements from sensor block 266 are communicated by host 254. Host 254 can provide some or all processing involved in workflow 200. Thus, in some examples, host 254 can perform setup step 204, loading step 208, all decisions 220, 224, 232, and 236 in workflow 200, and end step 240.

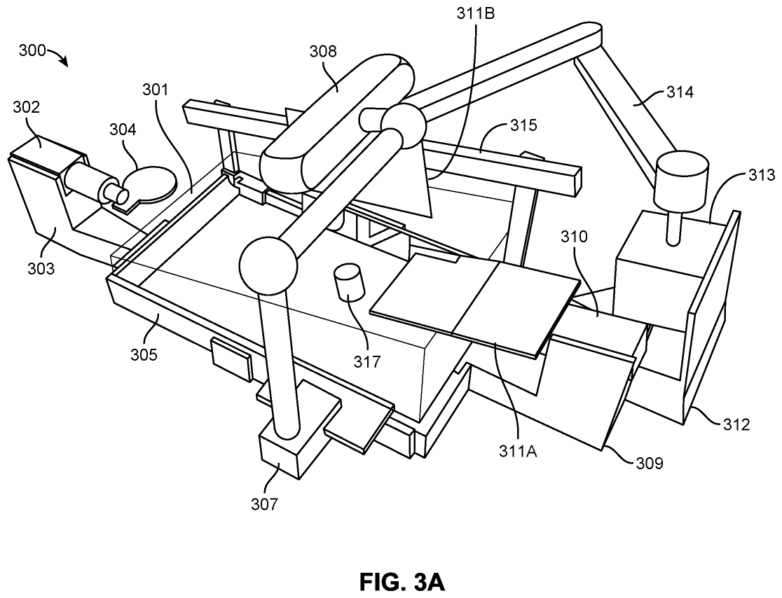

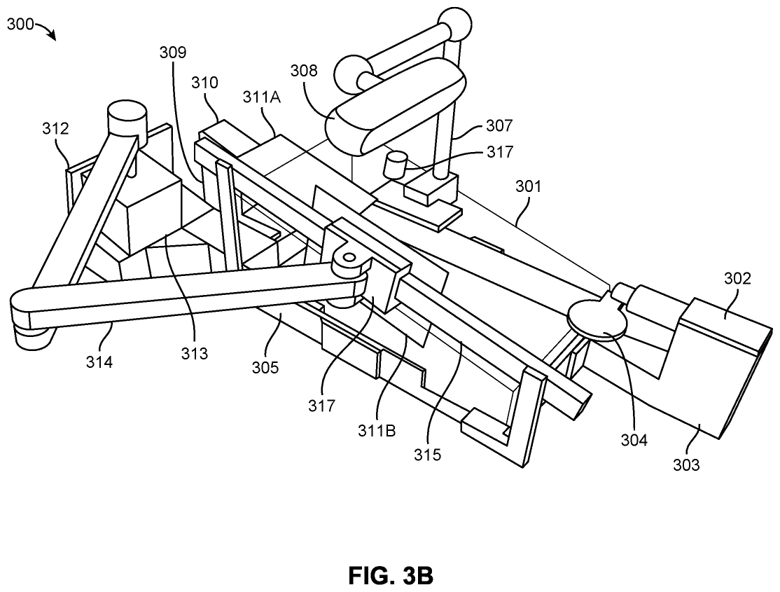

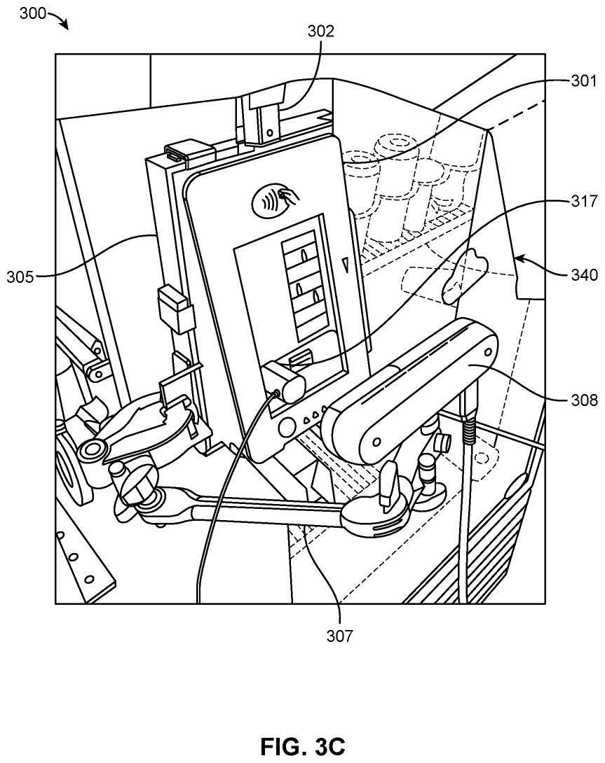

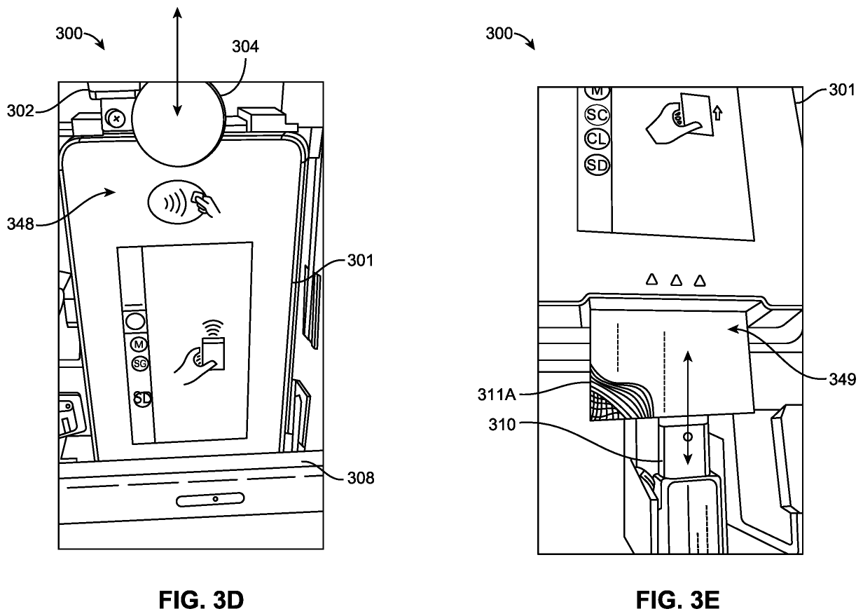

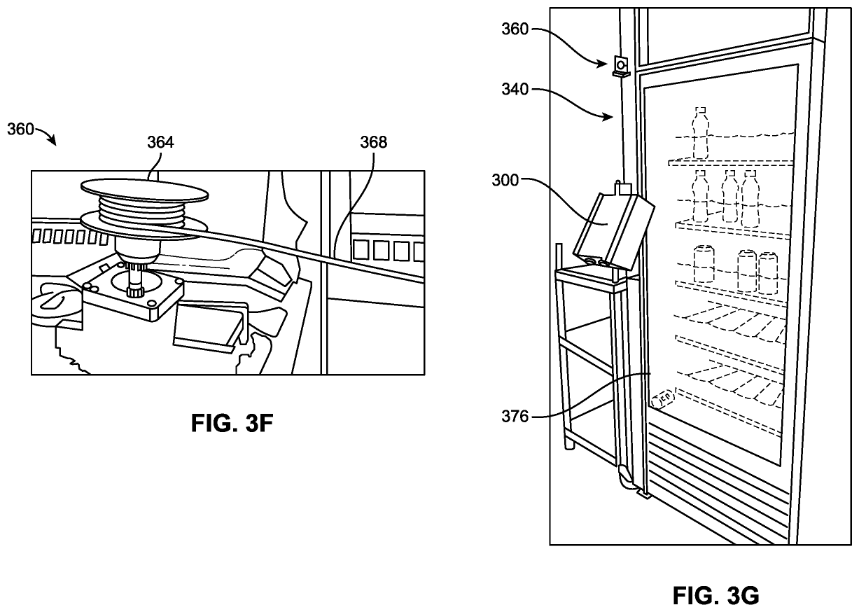

FIGS. 3A and 3B illustrate an automated consumer experience testing rig 300. Rig 300 is illustrated alongside a point of sale interface 301. Interface 301 is represented as transparent in FIGS. 3A and 3B for clarity. Rig 300 can have an onboard processor and a non-transitory, computer readable medium carrying instructions that, when read by the processor, cause the rig 300 to execute workflow 200 described above. In further examples, rig 300 can be in communication, such as wired or wireless network communication, with another device, such as the host computer of host block 254 of framework 250, comprising an onboard processor and a non-transitory, computer readable medium carrying instructions that, when read by the processor, cause the rig 300 to execute workflow 200 described above. In some examples, rig 300 can comprise any one or any combination of the IO controller 258, action block 262, and sensor block 266 of framework 250. In further examples, rig 300 can comprise host 254 of framework 250, while in other examples, host 254 is separate from rig 300 but in network communication with rig 300.

Rig 300 comprises a frame 305 that fits on interface 301. Frame 305 is thus configured to secure rig 300 to interface 301. Other components of rig 300 described herein are mounted to frame 305 or to one another so as to be collectively supported by frame 305. Thus, frame 305 supports other components of rig 300 such that movement of the other components relative to interface 301 can be controlled when frame 305 is secured to interface 301. In the illustrated example, all portions of rig 300 other than frame 305 are connected to frame 305 such that attaching frame 305 to interface 301 attaches rig 300 to interface 301. In other examples, rig 300 may comprise components not mounted to a common frame 305, and such components may be individually attachable to interface 301 or a machine that includes interface 301.

Rig 300 further comprises multiple components for simulating payment actions. In the illustrated example, the payment actions are forms of submission of payment cards, such as credit cards or debit cards, to the interface. However, rig 300 may comprise components for simulating payment actions that do not involve submission of payment cards to interface 301. In other examples, rig 300 may lack components for simulating submission of a payment card to interface 301.

Rig 300 comprises an actuator 302 connected to a near field communication (“NFC”) chip bracket 304. Another bracket 303 connects actuator 302 to frame 305. Actuator 302 is configured to move NFC chip bracket 304 between at least a first position at which an NFC chip held by NFC chip bracket 304 is outside of communication range of interface 301 and a second position at which the NFC chip held by NFC chip bracket 304 is within communication range of interface 301. As shown in FIG. 3D, interface 301 may comprise an NFC reader 348, and actuator 302 may move NFC chip bracket 304 relative to NFC reader 348. Actuator 302 and NFC chip bracket 304 thereby simulate NFC-based payment actions, sometimes referred to as “tap to pay,” which customers may enact by placing a payment card, mobile electronic device such as a smart phone, or other NFC enabled device in communication with interface 301. In the illustrated example, actuator 302 is a linear actuator, though in other examples actuator 302 may be any device configurable to controllably move NFC chip bracket 304 between the first position and the second position.

In some examples, the communication range can be a space defined relative to interface 301 that is coextensive with interface's 301 known capability to communicate with NFC devices. In such example wherein the communication range is coextensive with interface's 301 known capability to communicate with NFC devices, actuator 302 and NFC chip bracket 304 may be used to assess reliability of interface's 301 NFC connectivity by collecting data including when interface 301 fails to communicate with the NFC chip within NFC chip bracket 304 while the NFC chip is within the communication range. In some examples, the data can include a frequency at which interface 301 fails to communicate with the NFC chip within NFC chip bracket 304 while the NFC chip is within the communication range. In further examples, the data can include conditions surrounding successful communication between interface 301 and the NFC chip within NFC chip bracket 304, conditions surrounding failure of interface 301 to communicate with the NFC chip within NFC chip bracket 304, or both. The conditions can include any one of or any combination of a state of a machine that includes interface 301, an operating state of interface 301, inputs to interface 301 within a predetermined amount of time preceding the successful communication or failure to communicate, inputs to interface 301 within a predetermined number of inputs to interface 301 preceding the successful communication or failure to communicate, a computer log of the machine that comprises interface 301, equipment power usage, and sensor readings. The equipment power usage can be usage by any one or any combination of a processor of the machine that comprises interface 301, lights of the machine that comprises interface 301, a cooling system of the device that comprises interface 301, and an entirety of the machine that comprises interface. The sensor data can be, for example, data from a light sensor, a noise sensor, or any sensor or combination of sensors of the machine that comprises interface 301. The machine that includes interface 301 can be, for example, a vending machine, an automated merchantry system, or a controlled access product container.

In other examples, the communication range can be a space defined relative to interface 301 that is coextensive with interface's 301 expected capability to communicate with NFC devices. In such latter examples wherein the communication range is coextensive with interface's 301 expected capability of communicating with NFC devices, actuator 302 and NFC chip bracket 304 may be used to determine an actual extent of interface's 301 capability to communicate with NFC devices by collecting data including at what positions within actuator's 302 range of motion interface 301 can communicate with the NFC chip held by NFC chip bracket 304 and at what positions within actuator's range of motion interface 301 cannot communicate with the NFC chip held by NFC chip bracket 304.

With continued reference to FIGS. 3A and 3B, rig 300 also comprises linear actuator 310 connected to EMV chip 311A. EMV chip 311A may be included in rig 300 as a complete payment card, a portion of a payment card that comprises EMV chip 311A, or as an EMV chip isolated from a complete payment card. As shown in FIG. 3E, linear actuator 310 is configured to move EMV chip 311A between a first position at which EMV chip 311A is received in an EMV slot 349 of interface 301 to be readable by interface 301 and a second position at which EMV chip 311A is removed from EMV slot 349. Linear actuator 310 is thus configured to enable testing of payment by submission of an EMV chip payment card to interface 301. In such examples, rig 300 can further be used to test how reliably interface 301 reads inserted EMV chip 311A. In some examples, the data can include a frequency at which interface 301 fails to read the inserted EMV chip 311A. In further examples, the data can include conditions surrounding successful read of the inserted EMV chip 311A, conditions surrounding failure to read inserted EMV chip 311A, or both. The conditions can include any one of or any combination of a state of a vending machine that includes interface 301, an operating state of interface 301, inputs to interface 301 within a predetermined amount of time preceding the successful communication or failure to communicate, inputs to interface 301 within a predetermined number of inputs to interface 301 preceding the successful reads or failed reads, a computer log of the machine that comprises interface 301, equipment power usage, and sensor readings. The equipment power usage can be usage by any one or any combination of a processor of the machine that comprises interface 301, lights of the machine that comprises interface 301, a cooling system of the device that comprises interface 301, and an entirety of the machine that comprises interface. The sensor data can be, for example, data from a light sensor, a noise sensor, or any sensor or combination of sensors of the machine that comprises interface 301.

With continued reference to FIGS. 3A and 3B, rig 300 further comprises a card swipe assembly comprising a rail 315, a cart 316 that slides along rail 315 in response to movement of arm 314, and a magnetic strip 311B connected to cart 316. Magnetic strip 311B can be included in rig 300 as a complete payment card or as a portion of a payment card that includes magnetic strip 311B. In the illustrated example, the card swipe assembly further comprises a motor 313 and an arm 314 driven by motor 313. Arm 314 is a linkage connected at a first end to motor 313 and at a second end to rail 315. Motor 313 can be, for example, a stepper motor, a servo motor, or any other motor capable of controllably moving arm 314 to simulate a card swipe. Arm 314 is constrained such that rotation of motor 313 causes the second end of arm 314 to slide along rail 315. Motor 313 is rotatable in two directions such that the second end of arm 314 can be made to travel in either of two directions along rail 315. Arm 314 and cart 316 are respectively configured such that movement of the second end of arm 314 along rail 315 also causes cart 316 to move along rail 315. In particular, in the illustrated example the second end of arm 314 is connected to rail 315 by cart 316, though arm 314 may be otherwise configured to cause cart 316 to travel along rail 315 in other examples. Because magnetic strip 311B is connected to cart 316, moving cart 316 along rail also causes magnetic strip 311B to travel relative to interface 301. Rail 315 is positioned such that magnetic strip 311B passes through a magnetic strip reader of interface 301 when cart 316 travels along rail 315 if frame 305 is mounted to interface 301. Thus, the card swipe assembly of the illustrated example is configured such that the payment action of submitting a payment card to interface 301 by swiping the payment card's magnetic strip through interface's 301 magnetic strip reader can be simulated by activating motor 313. However, rig 300 according to other examples may instead comprise a card swipe assembly that can controllably pass magnetic strip 311B through a magnetic strip reader of interface 301 by any way other than the mechanisms of the card swipe assembly illustrated in FIGS. 3A and 3B and described above.

In the illustrated example, and in any examples comprising a card swipe assembly, rig 300 can be used to test interactions with interface 301 that include swiping a payment card through the magnetic strip reader. In such examples, rig 300 can further be used to test how reliably interface 301 reads swiped magnetic strips by collecting data including when interface 301 fails to read the swiped magnetic strip 311B. In some examples, the data can include a frequency at which interface 301 fails to read the swiped magnetic strip 311B. In further examples, the data can include conditions surrounding successful read of the swiped magnetic strip 311B, conditions surrounding failure to read swiped magnetic strip 311B, or both. The conditions can include any one of or any combination of swipe direction, a state of a vending machine that includes interface 301, an operating state of interface 301, inputs to interface 301 within a predetermined amount of time preceding the successful communication or failure to communicate, inputs to interface 301 within a predetermined number of inputs to interface 301 preceding the successful reads or failed reads, a computer log of the machine that comprises interface 301, equipment power usage, and sensor readings. The equipment power usage can be usage by any one or any combination of a processor of the machine that comprises interface 301, lights of the machine that comprises interface 301, a cooling system of the device that comprises interface 301, and an entirety of the machine that comprises interface. The sensor data can be, for example, data from a light sensor, a noise sensor, or any sensor or combination of sensors of the machine that comprises interface 301.

Actuator 302 with NFC chip bracket 304, linear actuator 310 with EMV chip 311A, and the card swipe assembly with magnetic strip 311B are three examples of components for simulating payment actions that rig 300 can comprise. In further examples, rig 300 can comprise any one, any two, or none of those three examples of components for simulating payment actions. In further examples, rig 300 can further comprise other components for simulating payment actions. The other components can be configured to simulate the payment actions associated with submission of a payment card to interface 301 or any other payment actions.

Rig 300 further comprises a camera 308 for observing outputs from interface 301. Rig 300 of the illustrated example also comprises a camera mount 307 connecting camera 308 to frame 305, though in other example camera 308 may not be connected to frame 305. Camera mount 307 can optionally be an adjustable mount such that a position of camera 308 relative to interface 301 can be adjusted. In some examples, rig 300 can be configured to use camera 308 for text recognition to verify that interface 301 displays messages and numbers correctly.

By using camera 308 to observe outputs from interface 301, rig 300 can be used to collect data relating to how reliably interface 301 responds as intended to user actions. Thus, camera 308 can be used to perform the collection of collecting step 216 within the workflow 200 described above. For example, rig 300 can be configured to use camera 308 to determine when interface 301 displays an output for too long of a time or too short of a time.

Rig 300 further comprises a stylus 317 for simulating manual inputs to interface 301. In some examples wherein interface 301 comprises one or more buttons, stylus 317 can be configured to press the buttons. In further examples wherein interface 301 comprises a touch screen, stylus 317 can be tipped with a material that the touch screen can detect and configured to controllably move into or out of contact with the touch screen in order to simulate touch inputs to interface 301. Stylus 317 can be controllably motorized to move relative to interface 301 as necessary to simulate all inputs to interface intended to be tested. Thus, in some examples, stylus 317 can be controllably motorized to move laterally relative to interface 301 to enable pressing differing buttons, touching different portions of a touch screen of interface 301, or swiping across a touch screen of interface 301. In further examples wherein all inputs to interface 301 intended to be tested can be simulated by pressing a single button or touching a single location on a touch screen of interface 301, stylus 317 can be controllably motorized to move relative to interface 301 only into and out of engagement with the single button or single location on the touch screen. Stylus 317 can be controllably motorized by being connected to a gantry integrated into rig 300. Thus, in various examples, stylus 317 can be controllably motorized to move along one axis with an “X gantry,” along two axes with an “XY gantry,” or along three axes with an “XYZ gantry.”

Rig 300 can be used with a door opener 360 as shown in FIGS. 3G and 3F. Door opener 360 of the illustrated embodiment comprises a spool 364 and a cord 368. Door opener 360 according to further examples can be any device capable of controllably opening and closing door 376. Cord 368 can be connected to door 376 of machine 340 to enable door opening 360 to open door 376 by rotating to increase tension on cord 368. In some examples, machine 340 can be tester target device 270 within framework 250. Door opener 360 can rotate in an opposite direction to decrease tension on cord 368 and allow door 376 to swing shut. Door opener 360 can therefore be controlled in cooperation with rig 300 to enable testing of functionality related to door 376 opening and closing. For example, door opener 360 can be used in cooperation with rig 300 to assess how many times door 360 can be opened or closed before part of machine 340 fails. In a further example, door opener 360 can be used in cooperation with rig 300 to test sequences of events that include door 376 openings or closings for likelihood to induce malfunction of interface 301.

The foregoing mechanisms of rig 300 and door opener 360 for interacting with machine 340 can be within action block 262 of framework 250. Thus, any of the above described mechanisms of rig 300 and door opener 360 can be used to perform attempt step 212 and retry step 228 within workflow 200. Rig 300 can further comprise any additional mechanisms for performing any actions on machine 340 disclosed herein as being within action block 262 of framework 250. Rig 300 can therefore comprise any one or any combination of a mechanism to turn a cooler of machine 340, a mechanism to remove a product from machine 340, a mechanism to insert a product into machine 340, and a mechanism to turn any network antennas of machine 340 on and off. Rig 300 can further comprise any additional sensors disclosed herein as being within sensor block 266. Rig 300 can therefore comprise any one or any combination of a microphone, a voltage sensor configured to measure a voltage used by any part of machine 340, a current sensor configured to measure a current drawn by any part of machine 340, a light sensor to determine an ambient illumination level independently of camera 308, a DAQ, and a temperature sensor. In further examples, any one or any combination of the foregoing sensors can be distributed around machine 340 and used in cooperation with rig 300 without being part of rig 300. Any such sensors, whether or not integrated into rig 300, can be used to perform collecting step 216 within workflow 200. Thus, any sensors of rig 300 or sensors used in cooperation with rig 300 may be within sensor block 266. Accordingly, in addition to any other sensors described herein with respect to rig 300, rig 300 can include any one or any combination of one or more QR code readers, one or more barcode readers, one or more NFC readers, one or more Narrow Band Internet of Things (“NB-IoT”) readers, and one or more Bluetooth Low Energy (“BLE”) readers.

Machine learning models can be used to refine and suggest testing protocols for the automated testing rig based on collected performance, failure, and optimization data. Thus, in some embodiments rig 300 can be configured to send collected data to a machine learning model, such as any of the machine learning models described herein, and use said machine learning to optimize and recommend new testing protocols. For example, rig 300 can be configured to send collected data to the machine learning model hosted in some embodiments by host 254 as described above.

It is to be appreciated that the Detailed Description section, and not the Summary and Abstract sections, is intended to be used to interpret the claims. The Summary and Abstract sections may set forth one or more but not all exemplary embodiments of the present disclosure but are not intended to limit the present disclosure and claims in any way.

The foregoing description of the specific embodiments so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the claims and their equivalents.

What is claimed is:

1. An intelligent distribution system comprising:
a distributed machine learning network comprising a plurality of end distribution components, wherein each end distribution component is configured to predict, based on end distributor data comprising distribution records from a respective end distribution device to retail facilities, future distribution patterns from the end distribution device to the retail facilities.

2. The system of claim 1, wherein the distributed machine learning network further comprises a plurality of regional distribution components, wherein each regional distribution component is configured to predict, based on regional distributor data comprising the distribution records from a respective plurality of the end distribution devices, future regional sales volume within a geographic region within which the plurality of end distribution devices is located, and wherein the future sales volume comprises sales of products distributed by the end distribution devices to the retail facilities.

3. The system of claim 2, wherein the distribution records comprise operation logs from product handling machinery installed in at least one of the end distribution centers.

4. The system of claim 2, wherein the distributed machine learning network further comprises a central component, wherein the central component is configured to predict, based on central data comprising the future regional sales volumes predicted by the regional distribution components, future global sales volumes of the products distributed by the end distribution devices to the retail facilities.

5. The system of claim 2, wherein the central component is further configured to predict, based on the central data, future manufacturing loads necessary to meet the predicted further global sales volumes.

6. The system of claim 1, wherein the end distributor data comprise retail data received from the retail facilities.

7. The system of claim 6, wherein the retail data received from at least one of the retail facilities comprises records generated by an automated stock monitoring system.

8. A method of testing a machine, the method comprising:
connecting a testing rig to the machine, wherein the testing rig is configured to simulate user interactions with the machine;
loading instructions to a controller of the testing rig, wherein the instructions comprise a sequence of interactions to be performed by the testing rig;
performing, with the testing rig, a first action in the sequence;
determining, with the testing rig, whether the machine provides expected feedback to the first action; and
using the testing rig to record output from the machine.

9. The method of claim 8, comprising using the testing rig to repeat the first action a predetermined number of times.

10. The method of claim 8, comprising retrying the first action a predetermined number of times, then performing, with the rig, a second action in the sequence.

11. The method of claim 8, comprising:
performing, with the rig, each action in the sequence at least once; and
after performing each action in the sequence at least once, restarting the sequence by performing the first action and determining whether the machine provides expected feedback to the first action.

12. The method of claim 8, comprising obtaining the sequence from a machine learning model trained on failure data of other machines.

13. A vending machine testing rig, comprising:
a card holder configured to submit a payment card to a user interface of a machine; and
a sensor configured to measure the vending machine's response to submission of the payment card to the user interface.

14. The testing rig of claim 13, comprising a stylus configured to simulate manual inputs to the user interface.

15. The testing rig of claim 13, comprising a motorized arm configured to submit the payment card to the user interface by swiping a magnetic strip of the payment card through a magnetic strip reader of the user interface.

16. The testing rig of claim 15, comprising an actuator configured to push a chip of the payment card into a chip reader of the user interface.

17. The testing rig of claim 13, comprising a frame to which the arm and the sensor are connected, wherein the frame is configured for mounting to the user interface.

18. The testing rig of claim 13, comprising a near field communication (“NFC”) chip and a motorized chip bracket configured to move the chip into and out of a communication range of an NFC reader of the interface.

19. The testing rig of claim 13, wherein the sensor is a camera.

20. The testing rig of claim 19, configured to determine whether the interface provides expected feedback to an action performed by the rig and recording feedback provided by the interface.

21. A system comprising:
the testing rig of claim 13; and
a computing device hosting a machine learning model, wherein the testing rig is configured to send data collected by the testing rig to the machine learning model and the machine learning model is configured to develop testing protocols to reproduce failure states identified in test data acquired by the testing rig.
